(19) United States
(12) Patent Application Publication
(10) Pub. No.: US 2022/0007602 A1
(43) Pub. Date: Jan. 13, 2022

(54) DEVICE AND SYSTEM FOR PLANT GROWING

(71) Applicant: NATUFIA SAUDI ARABIA FOR MANUFACTURING LLC, Thuwwal (SA)

(72) Inventors: Gregory LU, Tallinn (EE); Lauri KAPP, Tallinn (EE)

(73) Assignee: NATUFIA SAUDI ARABIA FOR MANUFACTURING LLC, Thuwwal (SA)

(21) Appl. No.: 17/293,118

(22) PCT Filed: Nov. 6, 2019
(86) PCT No.: PCT/EP2019/080424

§ 371 Date: May 12, 2021

(30) Foreign Application Priority Data
Nov. 13, 2018 (EP) 18206049.1

(51) Int. Cl. A01G 31/06

(52) U.S. Cl. CPC A01G 31/06

(57) ABSTRACT

Disclosed herein are devices and a system for hydroponically growing plants. A pod comprising a top surface, a bottom surface and at least one side surface, said side surface connecting the top surface and the bottom surface is disclosed. The pod body comprises an indentation. A contour of the top surface of the pod body is larger than a contour of the bottom surface of the body. Additionally or alternatively to the contours geometry, the pod comprises a protective layer forming a barrier between at least part of said indentation and surrounding medium. The system for growing plants comprises the pod and a socket configured to receive the pod. A contour of the bottom surface is smaller than a contour of the socket opening and a contour of the top surface is larger than a contour of the socket opening.

### CROSS-REFERENCE TO RELATED APPLICATIONS

This application is a national stage of International Application No. PCT/EP2019/080424, filed Nov. 6, 2019, which claims the benefit of European Application No. 18206049.1, filed Nov. 13, 2018, in the European Patent Office, the disclosures of which are incorporated herein by reference.

### FIELD

The invention relates to growing plants. More specifically, the invention relates to a device and system and method for hydroponic germination of plants.

### INTRODUCTION

Recently, hydroponic plant growing has been increasingly used in many areas. Indoor gardening is one such area that has been rapidly developing due to increasing demand. Indoor plant growing devices and systems can be used by businesses such as restaurants or by individuals for private use.

One such indoor plant growing device is disclosed in the applicant's patent application EP 3 251 499 A1, which discloses a hydroponic plant grow cabinet optimized for easy and simple use to grow plants hydroponically in a limited place.

Another such system for indoor plant cultivation is disclosed in European patent application EP 3 087 831 A1. The system is low cost, simple system that may be used for example at homes, in restaurants, and in schools to grow vegetables, flowers and other plants.

Such indoor plant growing devices can generally grow plants from a seed to a full-grown plant within a span of several days or weeks. Advantageously, the whole process can be performed by the device with minimal intervention by the user.

Indoor plant growing devices generally use certain mediums for storing and later germinating seeds, as well as supporting the seedling and later the plant.

German utility model DE 20 2014 101 486 U1 discloses a cartridge for use in a hydroponic gardening apparatus interior. The cartridge comprises a growth medium comprising a cover which is detachably arranged to cover said upper surface, which cover consists of a material which is opaque to the blue spectrum, i.e. about 400 to 500 nm, and the red spectrum, i.e. about 600 to 700 nm.

### SUMMARY

It is the object of the present invention to provide an improved and easy to use device and system for hydroponically growing plants. It is also an object of the present invention to disclose a biodegradable and easy to use device for growing plants. It is also an object of the invention to describe a device that can be used with a hydroponic plant growth cabinet.

In a first embodiment, a pod for hydroponically growing plants is disclosed. The pod comprises a body comprising a top surface, a bottom surface and at least one side surface. The side surface connects the top surface and the bottom surface. The body comprises an indentation. A contour of the top surface of the body is larger than a contour of the bottom surface of the body.

The pod described herein can be particularly advantageous for preserving seeds until germination should begin, and for supporting the seedling and later the plant once it has started. The shape of the pod, characterized by the larger contour of the top surface than of the bottom surface can advantageously allow to place it into an opening and for it to remain supported without an additional supporting element. In other words, no supporting cups made of plastic or similar non bio-degradable materials need be used with the present device. The shape can also be further characterized by a diameter of a circumscribing circle of the top surface being larger than a diameter of a circumscribing circle of the bottom surface.

The top, bottom and side surfaces may not be entirely smooth, as the material of the pod may comprise fibers, leading to rough surfaces. In this case, the surface may be understood as an averaged smooth surface.

There may be more than one side surfaces. For example, in some embodiments, the body can comprise at least one of a truncated conical shape and a truncated pyramid shape. In the case of a truncated conical shape, the side surface may comprise one surface. Conversely, for a truncated pyramid shape, the side surface may comprise a plurality of surfaces that connect at an angle.

In addition to supporting the pod in a hanging position (as is preferable for hydroponic plant growing, as roots generally require free space below the pod), the shape of the pod can be useful for the growing roots, which can reach open space after a smaller distance travelled as compared to more straight shapes, such as simple cylinders.

In some embodiments, the side surface can be symmetrical about an axis connecting a center of the contour of the top surface and a center of the contour of the bottom surface. Such a symmetrical pod shape can be simpler to manufacture and easier to handle.

In some embodiments, the side surface can substantially correspond to a surface of revolution created by rotating a line segment about the axis connecting a center of the contour of the top surface and a center of the contour of the bottom surface. The angle between a line comprising the line segment and said axis can comprise 5 to 60 degrees, preferably 5 to 45 degrees. In other words, the side surface can substantially correspond to a side surface of a truncated cone with the above angle. Such angles can ensure that the pod has sufficient support when suspended for plant growing process, while also keeping a compact shape that is optimal to use for plant growth.

In some embodiments, the ratio of the contour of the top surface to the contour of the bottom surface can comprise between 1.2 and 3, preferably between 1.5 and 2. The same ratio can apply to the diameters of circumscribing circles for each of those surfaces respectively. Such ratios can also advantageously allow for the pod to support itself when suspended and retain a compact and optimal shape for seed storage, germination and plant growing.

In some embodiments, the pod can further comprise a protective layer. The protective layer can form a barrier between at least a part of the indentation in the body and surrounding medium. Surrounding medium can refer to immediate surroundings of the pod, in other words, the air and objects in its immediate vicinity. Forming such a barrier can advantageously allow to separate the indentation and its contents from the surroundings. Preferably, seeds can be placed within an indentation, and the protective layer can be used to separate them from the surrounding air, which might comprise a high humidity and can lead to early germination. Preferably, the protective layer is placed across at least a part of the indentation in such a way that prevents or severely limits air exchange between the inside of the indentation and the surroundings.

In some embodiments, the protective layer can be soluble in liquid. Preferably, the protective layer can be soluble in water. Such property can be particularly useful for ensuring that germination of the seeds does not start prematurely. When exposed to water (or water with nutrients), the protective layer can melt away, allowing the seeds to start germination.

In some embodiments, the protective layer can be humidity absorbent. As mentioned above, this can be particularly advantageous to prevent early seed germination placed within the indentation of the body.

In some embodiments the protective layer can be configured to prevent germination of seeds placed into the indentation in the body. However, the protective layer is preferably easy to dissolve, so that germination may start when the pod is placed from storage into a plant growing device (such as a plant growing cabinet for example). While the protective layer is intact, germination may be prevented. This can be achieved both by chemical structure of the protective layer, as well as its topology on its own and with respect to placement near the indentation in the pod's body.

In some embodiments, the protective layer can have a substantially circular cross-section. In some such embodiments, the protective layer can have a surface area substantially corresponding to a truncated spherocylinder. In other words, the protective layer can comprise a hollow solid or semi-solid. For example, the protective layer can comprise a capsule, or part of a capsule inside which seeds can be placed. This can be particularly advantageous, as it can allow to create and maintain isolated physical conditions for the seeds within the protective layer.

In some embodiments, the protective layer can comprise a thickness of 0.01 to 0.4 cm. This can be optimal thickness to ensure that the seeds do not start germinating early, while allowing for the protective layer to melt or be stripped away once germination should be started.

In some embodiments, the protective layer can be biodegradable. This is particularly advantageous, as it can allow for reducing waste associated with growing plants and utilizing the resources efficiently. In a preferred embodiment, the protective layer can comprise gelatin. This can be far more advantageous than using other water-soluble substances. Other substances that fail to dissolve entirely, leaving behind clumps and traces, which can get caught on the pod, subsequently end up on growing plants, or get to sensitive components of the hydroponic plant growing device (once the pod is placed within it and germination has started), and cause malfunctions.

In some embodiments, the protective layer can comprise an enclosed space. As briefly mentioned above, enclosing seeds within a protective layer can be the most efficient and simple way of preventing their early germination. Additionally, the protective layer and the pod can be manufactured and stored separately, and combined only immediately preceding planned germination start. In this way, the seeds can be protected and isolated until the protective layer dissolves or dissipates (preferably due to the start of watering). In some such embodiments, the enclosed space can comprise at least one atmospheric parameter independent of protective layer surroundings' atmospheric parameters. This parameter can comprise humidity, air pressure, air temperature and/or similar parameters. Advantageously, this can allow to maintain optimal physical parameters for the seeds while in storage and before germination starts.

In some embodiments, the pod can comprise mineral wool. In other embodiments, the pod can comprise polyadic acid. In some other embodiments, it can comprise jute. In yet other embodiments, the pod can comprise floral foam. Such non-woven materials can be particularly advantageous as plant growth mediums. They can allow for hydroponic plant development and thriving.

In some embodiments, the pod can further comprise water soluble adhesive. That is, the pod can be partially glued together, or have water soluble glue applied to the outside surfaces of its body (preferably the side surface). This can help maintain pod integrity while in storage and further prevent early germination by separating the inside of the pod from humidity.

In some embodiments, the pod can be biodegradable. As described above, this can advantageously allow to reduce waste of resources and optimize energy expenditures associated with manufacturing and waste management.

In some embodiments, the pod can further comprise a supporting layer. The supporting layer can be configured to maintain pod integrity. That is, the supporting layer can serve to further ensure that the pod can be supported as it is suspended for plant growth. The supporting layer can be adjacent to the top surface.

In some embodiments, the pod can comprise two joined cylinders. The top surface can lie on a first cylinder and the bottom surface can lie on a second cylinder. In other words, the pod can comprise a solid T shape with the thicker part on top, and thinner part below it. Such a shape can allow the pod to hang suspended by its top part. Compared to known prior art embodiments, the pod of the present application need not comprise a separate holder, usually made of plastic, and can be supported by its own weight. This can advantageously allow to reduce the use of plastic or the need for extra components in hydroponic plant growing.

In a second embodiment, a pod for growing plants is disclosed. The pod comprises a body comprising a top surface, a bottom surface and at least one side surface. The side surface connects the top surface and the bottom surface. The pod further comprises a protective layer. The body of the pod comprises an indentation. The protective layer forms a barrier between at least part of said indentation and surrounding medium.

The pod of this second embodiment advantageously allows to insulate or protect the indentation in the body, where seeds may be placed, from the surrounding medium such as air or nearby objects. The germination of seeds can be prevented for as long as the protective layer is present and intact. This can be achieved by, at least in part, limiting the exposure of the seeds to humidity.

While the second embodiment differs from the first embodiment (in that the geometric restriction of the pod is optional), both embodiments and all of the optional embodiments of either of them can be combined, and therefore should be interpreted by the skilled person as applying to either of the two independent embodiments.

In some embodiments, the protective layer can form a barrier across the indentation in the body. This can be a partial barrier, so that the protective layer only covers the top of the indentation. Conversely, the protective layer can also enclose seeds. Both embodiments are possible and advantageous. In the first case, the protective layer can be preferably curved, with a largest diameter preferably exceeding that of the indentation.

In some embodiments, the protective layer can be soluble in liquid, preferably in water. In this way, once it is desired to start germination of the seeds, a user may apply watering to the pod (or cause it to be automatically applied).

In some embodiments, the protective layer can be humidity absorbent.

In some embodiments, the protective layer can be configured to prevent germination of seeds placed into the indentation in the body.

In some embodiments, the protective layer can have a substantially circular cross-section. In some such embodiments, the protective layer can have a surface area substantially corresponding to a truncated spherocylinder. For example, the protective layer can comprise a surface area substantially corresponding to a capsule, or a truncated capsule. The seeds can then be safely placed within the capsule or under the dome of the truncated capsule. This can prevent their germination, as well as prevent their displacement within the pod.

The protective layer can comprise a thickness of 0.01 to 0.4 cm. As mentioned above, this can comprise an optimal thickness for preventing early germination and allowing it soon after it is desired.

The protective layer can be preferably biodegradable. In a preferred embodiment, the protective layer can comprise gelatin.

In some embodiments, the protective layer can comprise an enclosed space. As outlined above, this can allow for optimal protection of the seeds from the surroundings. The enclosed space can comprise at least one atmospheric parameter independent of protective layer surroundings' atmospheric parameters.

In some the protective layer can be configured to fix seeds within the enclosed space. In other words, the seeds can be placed into the protective layer, and prevented from moving, except within its enclosed space. The protective layer can also prevent seeds from moving within the pod when it is not enclosed. In such embodiments, the protective layer can form a roof or dome over the seeds, and prevent them from leaving the pod or migrating within it.

In some embodiments, a contour of the top surface of the body can be larger than a contour of the bottom surface of the body. Similarly, a diameter of a circumscribed circle of the top surface may be larger than a diameter of a circumscribed circle of the bottom surface.

In some embodiments, the body can comprise at least one of a truncated conical shape and a truncated pyramid shape.

In some embodiments, the side surface can be symmetrical about an axis connecting a center of the contour of the top surface and a center of the contour of the bottom surface.

In some embodiments, the side surface can substantially correspond to a surface of revolution created by rotating a line segment about the axis connecting a center of the contour of the top surface and a center of the contour of the bottom surface, and the angle between a line comprising the line segment and said axis can comprise 5 to 85 degrees, preferably 5 to 45 degrees.

In some embodiments, the ratio of the contour of the top surface to the contour of the bottom surface can comprise between 1.2 and 3, preferably between 1.5 and 2.

In some embodiments, the pod can further comprise a supporting layer. The supporting layer can be configured to maintain pod integrity. The supporting layer can be adjacent to the top surface.

The pod can comprise two joined cylinders and the top surface can lie on a first cylinder and the bottom surface can lie on a second cylinder.

In some embodiments, the protective layer can be fitted to the body of the pod configured to withstand a separating force of at least 0.01 N, preferably at least 0.1 N. In other words, the protective layer can be joined to the body of the pod in such a way that it would not easily separate due to being upside down (and under effects of gravity), or while being shaken (due to transportation or similar). Such holding force can be achieved, for example, by having the largest diameter of the protective layer be slightly larger than that of the indentation of the pod body, and forcibly fitting them together. The elasticity of the protective layer and/or of the pod, as well as friction can then provide sufficient holding force.

In a third embodiment, a system for growing plants is disclosed. The system comprises a pod comprising a body comprising a top surface, a bottom surface and at least one side surface. The side surface connects the top surface and the bottom surface. The system further comprises a socket comprising an opening configured to receive the pod. A contour of the bottom surface is smaller than a contour of the socket opening. A contour of the top surface is larger than a contour of the socket opening.

The present system is preferably configured to provide conditions suitable for germination, growing and thriving of plants. The pod can fit into the socket in such a way that a part of it can be suspended. In this way, seeds that are preferably placed into the pod can germinate and the roots can have space for growing.

The socket can comprise a cup, such as a ceramic cup. The pod and socket can be placed into a plant growing device (such as a plant growing cabinet of the applicant), where plants can be grown via a plurality of pods and cups.

Advantageously, the present system provides a pod fitting into a socket without a further support element such as a plastic basket that would hold the pod in place. The shape of the pod itself allows it to be supported when inserted into the socket. There may be further reinforcing elements such as those described above and below, but the system preferably comprises biodegradable components and no single use or reusable but easy to accidentally dispose of components.

In some embodiments, the socket can further comprise a socket cavity accessible via the socket opening. That is, the socket cavity can open up into a larger space, which can be contained within the socket. In other words, the socket cavity may be enclosed by socket body, with the only opening through the socket opening. For example, the socket may comprise a container such as one shown in FIGS. 4a and 4b (also referred to as cup).

In some such embodiments, the system can be configured to restrict light reaching the socket cavity when the pod is placed into the socket. This can be achieved by providing a snug fit between the pod and the socket opening, particularly by providing a shape of the pod that can snugly fit and support its weight.

In some embodiments, ratio of pod body portion with a diameter smaller than the socket opening to pod body portion with a diameter larger that the socket opening is at least 5, preferably at least 8, such as at least 10. In other words, most of the pod body may fit through the socket opening, with only about a fifth, preferably about an eighth, such as about a tenth remaining above the socket opening when the pod and socket are fit together. This can advantageously allow to isolate most of the pod's surface area from illumination, which can lead to the growth of algae. The pod can be constructed in such a way that the remaining portion can support the weight of the suspended pod. There can be additional reinforcing elements as well, as further detailed below.

In some embodiments, upon fitting the pod to the socket, a portion of the pod can be configured to protrude above the opening. A maximum height of the protruding pod portion can comprise at least one of 1 mm and 1/10 of total pod height. The protruding portion can serve as support for the pod suspended from the socket opening and further allow the seeds placed in the pod to be exposed to light once they start germinating (prior to germination, light exposure for seeds is preferably limited).

In some embodiments, the system can further comprise a protective layer. The protective layer can be configured to be fitted to an indentation of the pod body. The protective layer can serve to separate seeds, placed either within the indentation of the pod body, or within the protective layer itself, from outside conditions. For example, the protective layer can isolate the seed from ambient humidity, which might otherwise trigger early germination.

In some embodiments, the protective layer can comprise a capsule configured to encapsulate seeds. That is, the seeds can be placed within the protective layer and stored separately from the pod and the socket. When it is desired to start growing a certain plant, the protective layer containing the seeds can be fitted with the pod (preferably placed within an indentation of it), which in turn can be fitted with the socket. Additionally, the socket can be placed into a device for growing plants, where the plant can be automatically or mostly automatically grown.

In some embodiments, the system can further comprise a supporting layer. The supporting layer can be configured to maintain pod integrity. The supporting layer can comprise preferably a biodegradable material that can help reinforce the pod as it is suspended within the socket.

The supporting layer can be configured to be simultaneously adjacent to the pod and the socket. In other words, the supporting layer can be placed around or adjoining part of the pod, while also adjoining part of the socket. This can advantageously allow it to reinforce both structural integrity of the pod, as well as increase holding force between the pod and the socket.

In some embodiments, the supporting layer can be configured to envelop at least part of the pod body up to a point where a contour of the body is equal to the contour of the socket opening. That is, the supporting layer can preferably be placed around the part of the pod protruding above the socket opening when the pod and socket are fitted together. In this way, the supporting layer can help prevent algae growth on the parts of the pod exposed to ambient surroundings, and particularly to light.

In some embodiments, the supporting layer can comprise an aperture adjoining at least part of the top surface. That is, the supporting layer can cover all of the surface area of the pod protruding above the socket opening, with an aperture left for a plant to grow through.

In some embodiments, the protective layer can be configured to form a barrier between the aperture and surrounding medium. That is, the aperture can be further covered by the protective layer, in order to avoid early germination. The protective layer can then dissolve or dissipate when germination is intended to start (for example via the start of the watering process).

The pod of the present system can be as described in the embodiments above.

The present system can also be configured to be used with a hydroponic plant growth cabinet. That is, the pod and socket can be fitted together, and placed inside such a plant growth cabinet. There, appropriate light and watering conditions may be applied, so that seeds placed in the pod can germinate and a plant can grow from the pod with the root system extending into the socket.

In a fourth embodiment, a use of a pod as described in the above described embodiments for hydroponically growing plants is disclosed. The use can further comprise the pod being placed into a hydroponic plant growth cabinet.

The present invention is also defined by the following numbered embodiments.

Below is a list of device embodiments. Those will be indicated with a letter “A”. Whenever such embodiments are referred to, this will be done by referring to “A” embodiments.

A1. A pod for hydroponically growing plants, the pod comprising

A body comprising a top surface, a bottom surface and at least one side surface, said side surface connecting the top surface and the bottom surface;
Wherein the body comprises an indentation; and
Wherein a contour of the top surface of the body is larger than a contour of the bottom surface of the body.

A2. The pod according to the preceding embodiment wherein the body comprises at least one of a truncated conical shape and a truncated pyramid shape.

A3. The pod according to any of the preceding embodiments wherein the side surface is symmetrical about an axis connecting a center of the contour of the top surface and a center of the contour of the bottom surface.

A4. The pod according to any of the preceding embodiments wherein the side surface substantially corresponds to a surface of revolution created by rotating a line segment about the axis connecting a center of the contour of the top surface and a center of the contour of the bottom surface, and wherein the angle between a line comprising the line segment and said axis comprises 5 to 60 degrees, preferably 5 to 45 degrees.

A5. The pod according to any of the preceding embodiments wherein the ratio of the contour of the top surface to the contour of the bottom surface comprises between 1.2 and 3, preferably between 1.5 and 2.

A6. The pod according to any of the preceding embodiments further comprising a protective layer.

A7. The pod according to the preceding embodiment wherein the protective layer forms a barrier between at least a part of the indentation in the body and surrounding medium.

A8. The pod according to any of the two preceding embodiments wherein the protective layer is soluble in liquid.

A9. The pod according to the preceding embodiment wherein the protective layer is soluble in water.

A10. The pod according to any of the four preceding embodiments wherein the protective layer is humidity absorbent.

A11. The pod according to any of the five preceding embodiments wherein the protective layer is configured to prevent germination of seeds placed into the indentation in the body.

A12. The pod according to any of the six preceding embodiments wherein the protective layer has a substantially circular cross-section.

A13. The pod according to any of the seven preceding embodiments wherein the protective layer has a surface area substantially corresponding to a truncated spherocylinder.

A14. The pod according to any of the preceding eight embodiments wherein the protective layer comprises a thickness of 0.01 to 0.4 cm.

A15. The pod according to any of the preceding nine embodiments wherein the protective layer is biodegradable.

A16. The pod according to any of the preceding embodiments and with the features of embodiment A6 wherein the protective layer comprises an enclosed space.

A17. The pod according to the preceding embodiment wherein the enclosed space comprises at least one atmospheric parameter independent of protective layer surroundings' atmospheric parameters.

A18. The pod according to any of the preceding embodiments comprising mineral wool.

A19. The pod according to any of the preceding embodiments comprising polyadic acid

A20. The pod according to any of the preceding embodiments comprising jute.

A21. The pod according to any of the preceding embodiments comprising floral foam.

A22. The pod according to the preceding embodiment further comprising water soluble adhesive.

A23. The pod according to any of the preceding embodiments wherein the pod is biodegradable.

A24. The pod according to any of the preceding embodiments further comprising a supporting layer.

A25. The pod according to the preceding embodiment wherein the supporting layer is configured to maintain pod integrity.

A26. The pod according to any of the two preceding embodiments wherein the supporting layer is adjacent to the top surface.

A27. The pod according to any of the preceding embodiments comprising two joined cylinders and wherein the top surface lies on a first cylinder and the bottom surface lies on a second cylinder.

A28. A pod for growing plants, the pod comprising

A body comprising a top surface, a bottom surface and at least one side surface, said side surface connecting the top surface and the bottom surface

A protective layer,
Wherein the body comprises an indentation; and
Wherein the protective layer forms a barrier between at least part of said indentation and surrounding medium.

A29. The pod according to the preceding embodiment wherein the protective layer forms a barrier across the indentation in the body.

A30. The pod according to any of the two preceding embodiments wherein the protective layer is soluble in liquid.

A31. The pod according to the preceding embodiment wherein the protective layer is soluble in water.

A32. The pod according to any of the four preceding embodiments wherein the protective layer is humidity absorbent.

A33. The pod according to any of the five preceding embodiments wherein the protective layer is configured to prevent germination of seeds placed into the indentation in the body.

A34. The pod according to any of the six preceding embodiments wherein the protective layer has a substantially circular cross-section.

A35. The pod according to any of the seven preceding embodiments wherein the protective layer has a surface area substantially corresponding to a truncated spherocylinder.

A36. The pod according to any of the preceding eight embodiments wherein the protective layer comprises a thickness of 0.01 to 0.1 cm.

A37. The pod according to any of the preceding nine embodiments wherein the protective layer is biodegradable.

A38. The pod according to any of the preceding embodiments A28 to A37 wherein the protective layer comprises an enclosed space.

A39. The pod according to the preceding embodiment wherein the enclosed space comprises at least one atmospheric parameter independent of protective layer surroundings' atmospheric parameters.

A40. The pod according to any of the preceding embodiments A28 to A39 wherein the protective layer is configured to fix seeds within the enclosed space.

A41. The pod according to any of the preceding embodiments A28 to A40 wherein a contour of the top surface of the body is larger than a contour of the bottom surface of the body.

A42. The pod according to the preceding embodiment wherein the body comprises at least one of a truncated conical shape and a truncated pyramid shape.

A43. The pod according to any of the two preceding embodiments wherein the side surface is symmetrical about an axis connecting a center of the contour of the top surface and a center of the contour of the bottom surface.

A44. The pod according to any of the three preceding embodiments wherein the side surface substantially corresponds to a surface of revolution created by rotating a line segment about the axis connecting a center of the contour of the top surface and a center of the contour of the bottom surface, and wherein the angle between a line comprising the line segment and said axis comprises 5 to 85 degrees, preferably 5 to 45 degrees.

A45. The pod according to any of the four preceding embodiments wherein the ratio of the contour of the top surface to the contour of the bottom surface comprises between 1.2 and 3, preferably between 1.5 and 2.

A46. The pod according to any of the preceding embodiments A28 to A45 further comprising a supporting layer.

A47. The pod according to the preceding embodiment wherein the supporting layer is configured to maintain pod integrity.

A48. The pod according to any of the two preceding embodiments wherein the supporting layer is adjacent to the top surface.

A49. The pod according to any of the preceding embodiments A28 to A48 comprising two joined cylinders and wherein the top surface lies on a first cylinder and the bottom surface lies on a second cylinder.

A50. The pod according to any of the preceding embodiments A28 to A49 wherein the protective layer is fitted to the body of the pod configured to withstand a separating force of at least 0.01 N, preferably at least 0.1 N.

Below is a list of system embodiments. Those will be indicated with a letter “S”. Whenever such embodiments are referred to, this will be done by referring to “S” embodiments.

S1. A system for growing plants, the system comprising

A pod comprising a body comprising a top surface, a bottom surface and at least one side surface, said side surface connecting the top surface and the bottom surface; and

A socket comprising an opening configured to receive the pod;

Wherein a contour of the bottom surface is smaller than a contour of the socket opening; and

Wherein a contour of the top surface is larger than a contour of the socket opening.

S2. The system according to the preceding embodiment wherein the socket further comprises a socket cavity accessible via the socket opening.

S3. The system according to the preceding embodiment configured to restrict light reaching the socket cavity when the pod is placed into the socket.

S4. The system according to any of the two preceding system embodiments wherein ratio of pod body portion with a diameter smaller than the socket opening to pod body portion with a diameter larger that the socket opening is at least 5, preferably at least 8, such as at least 10.

S5. The system according to any of the three preceding embodiments wherein upon fitting the pod to the socket, a portion of the pod is configured to protrude above the opening.

S6. The system according to the preceding embodiment wherein a maximum height of the protruding pod portion comprising at least one of 1 mm and 1/10 of total pod height.

S7. The system according to any of the preceding system embodiments further comprising a protective layer.

S8. The system according to the preceding embodiment wherein the protective layer is configured to be fitted to an indentation of the pod body.

S9. The system according to any of the two preceding embodiments wherein the protective layer comprises a capsule configured to encapsulate seeds.

S10. The system according to any of the preceding embodiments further comprising a supporting layer.

S11. The system according to the preceding embodiment wherein the supporting layer is configured to maintain pod integrity.

S12. The system according to any of the two preceding embodiments wherein the supporting layer is configured to be simultaneously adjacent to the pod and the socket.

S13. The system according to any of the three preceding embodiments wherein the supporting layer is configured to envelop at least part of the pod body up to a point where a contour of the body is equal to the contour of the socket opening.

S14. The system according to the preceding embodiment wherein the supporting layer comprises an aperture adjoining at least part of the top surface.

S15. The system according to the preceding embodiment and with the features of embodiment S7 wherein the protective layer is configured to form a barrier between the aperture and surrounding medium.

S16. The system according to any of the preceding system embodiments wherein the pod is according to any of the embodiments A1 to A50.

S17. The system according to any of the preceding system embodiments configured to be used with a hydroponic plant growth cabinet.

Below is a list of use embodiments. Those will be indicated with a letter “U”. Whenever such embodiments are referred to, this will be done by referring to “U” embodiments.

U1. Use of a device according to embodiments A1 to A50 for hydroponically growing plants.

U2. Use according to the preceding embodiment wherein the device is placed into a hydroponic plant growth cabinet.

The present technology will now be discussed with reference to the accompanying drawings.

### BRIEF DESCRIPTION OF THE DRAWINGS

FIGS. 1a and 1b depict an embodiment of a pod for growing plants, shown in a side view in FIG. 1a, and a bottom view in FIG. 1b;

FIGS. 2a and 2b depict further embodiments of a pod for growing plants with a protecting layer;

FIGS. 3a and 3b depict embodiments of a pod for growing plants fitted to a socket, shown in a side view;

FIGS. 4a and 4b depict embodiments of a pod for growing plants and a socket for fitting the pod, where the pod and socket are shown side by side in FIG. 4a, and fitted together in FIG. 4b.

### DESCRIPTION OF EMBODIMENTS

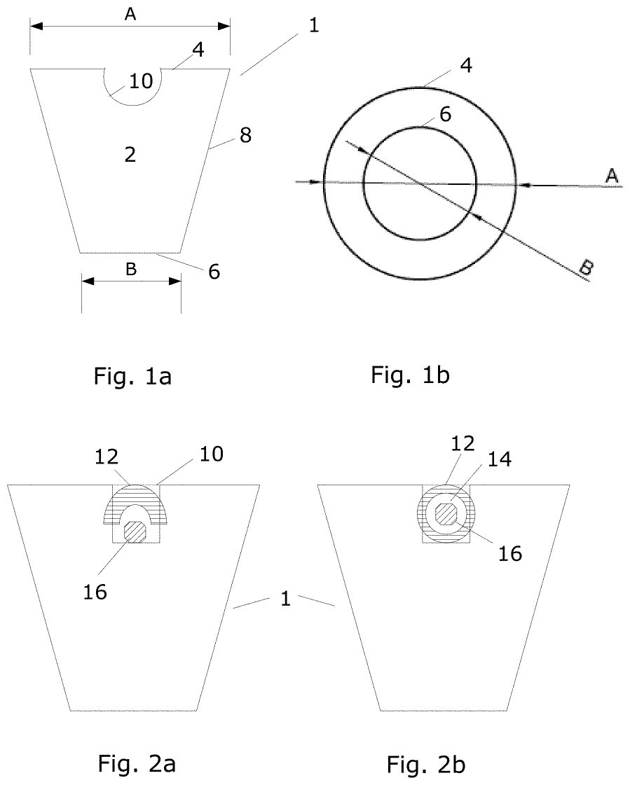

FIGS. 1a and 1b shows an embodiment of a pod for growing plants from a side view and bottom view respectively.

The pod 1 comprises a body 2. The pod 1 comprises a top surface 4, located at the top of the body 2. The pod 1 also comprises a bottom surface 6, correspondingly located at the bottom of the body 2. Side surface 8 joins the top surface 4 and the bottom surface 6, running around the body 2. The side surface may comprise one or more surfaces. For example, the side surface may comprise one smooth conical surface. In another example, the side surface 8 may comprise a plurality of joined planes, such as a truncated pyramidal surface.

There may be a plurality of side surfaces 8 that are not directly joined to each other. For example, the pod 1 may comprise a solid “T” shape comprising two cylinders with different diameters joined together. In this embodiment, the side surface 8 may comprise both side surfaces of the two cylinders. The top surface 4 may then comprise the top surface of one of the cylinders, and the bottom surface 6 may comprise the bottom surface of the other cylinder.

The top surface 4 comprises a larger contour than the bottom surface 6. That is, a tracing of the top surface 4 is larger than that of the bottom surface 6. Generally, the surface area of the top surface 4 is also larger than that of the bottom surface 6. However, this surface area then needs to be computed by including an area of an indentation 10, which is generally placed in the top surface 4.

The pod indentation 10 can be a circular or differently shaped indentation. It can have a height of at least 1/10 of the height of the pod 1. The indentation 10 may be used to place seeds into the pod 1.

FIG. 1a shows lines A and B, corresponding to diameters of the top surface 4 and bottom surface 6 respectively, in the case where they are substantially circular. When they are not, the lines A and B can correspond to the diameters of circles circumscribed around them respectively. The length of line A is larger than the length of line B. This is corresponding to the contour of the top surface 4 being larger than the contour of the bottom surface 6.

FIG. 1b shows a bottom view of the pod 1. The bottom surface 6 and the top surface 4 are visible. They are shown in FIG. 1b as circles, but this is exemplary, as they can also comprise a different shape, such as a polygon. The shapes of the top and bottom surfaces can also be different. Lines A and B are shown in the bottom view as well. As before, A>B.

FIGS. 2a and 2b show embodiments of a pod for growing plants comprising a protective layer 12.

FIG. 2a shows the pod 1 with an indentation 10 (shaped here differently than in FIG. 1a for exemplary purposes). The protective layer 12 forms a barrier between the pod indentation 10 and surrounding medium. In other words, the protective layer 12 separates the inside of the indentation 10 from ambient surroundings. A seed or seeds 16 are shown in the indentation 10, protected by the protective layer 12. The protective layer 12 can generally be suited to prevent early germination of the seeds 16, before the pod 1 is placed within a hydroponic plant growth cabinet where the plant can be grown. This can primarily mean that the protective layer 12 ensures that the seeds 16 remain within the indentation, and limits and humidity exposure due to ambient medium.

The protective layer 12 is shown in FIG. 2a as a semicircle. This can be one embodiment of the protective layer. However, the protective layer 12 can also comprise a layer which extends across all of the indentation 10 and/or all of the top surface 4.

Preferably, the protective layer is manufactured from a water-soluble material. For example, the protective layer can comprise gelatin, such as a gelatin capsule, or a part of a gelatin capsule.

In FIG. 2b, the protective layer encapsulates or encloses the seeds 16. This is one preferred embodiment, as it can advantageously allow for storage of the seeds 16 separately from the pod 1, and their placement within a pod immediately preceding germinating the seeds 16. In other words, the encapsulating protective layer 12 comprising the seeds 16 may be stored separately from the pod 1. In this way, the pod 1 can be made fungible, as a plurality of different seeds can be placed into its indentation 10 within the encapsulating protective layer 12. The pods 1 and the protective layer 12 with the seeds 16 can then be manufactured and stored separately until later combination for starting germination.

The encapsulating protective layer 12 can also be more efficient in preventing early germination, as it can completely isolate or separate the seeds 16 from the surrounding medium.

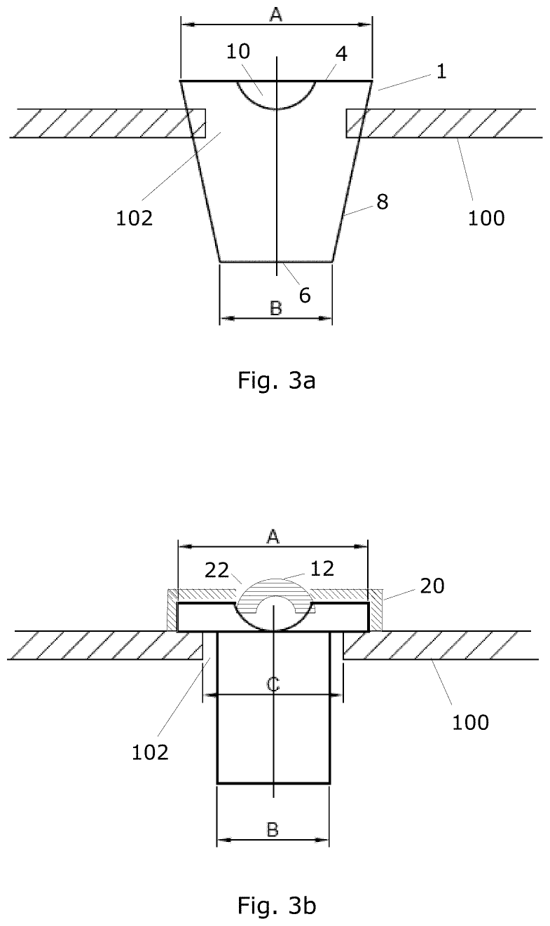

FIGS. 3a and 3b depict embodiments of a pod 1 fitted with a socket 100.

FIG. 3a shows a pod 1 with a truncated conical shape fitted to a socket 100. The socket 100 comprises a socket opening 102, where the pod 1 may be inserted. The line segment B, corresponding to a diameter of a circumscribing circle of the bottom surface 6 is shorter than the length of the socket opening 102. Conversely, the line segment A, corresponding to a diameter of a circumscribing circle of the top surface 4 is longer than the length of the socket opening 102. In this way, the truncated conical (or truncated pyramidal) shape of the pod 1 advantageously allows it to be supported by the socket 100.

When fitted to the socket 100, a part of the pod 1 remains above the opening 102. This part may comprise about 1/10 of the height of the pod 1 or so. The part may additionally or alternatively comprise about 1 mm. The opening 10 in the top surface 4 remains above the opening 102. This is to allow seedlings to grow upwards from the opening 10.

FIG. 3b shows an alternative shape of the pod 1 also discussed above. This shape comprises two stacked cylinders with different diameters. The diameter of the top cylinder (corresponding to the length of the line segment A in the case of circular cylinder) is larger than the diameter of the bottom cylinder (corresponding to the length of the line segment B in the case of the circular cylinder). Line segment C corresponds to the length of the socket opening 102. This length is larger than that of the line segment B and smaller than that of the line segment A. Therefore, the relationship A>C>B applies.

Also shown in FIG. 3b is the protective layer 12 placed on top of the pod indentation 10. The protective layer 12 generally remains above the socket opening 102 when the pod 1 is placed inside it. The depth of the indentation 10 need not correspond to the height of the first cylinder in this scenario, it may be smaller or larger.

Further shown is a supporting layer 20. The supporting layer 20 may serve to support the integrity of the pod and to also separate the part of the pod body 2 protruding above the socket opening 102 from the surrounding medium. This can be useful, for example, to avoid algae growth on the pod 1.

The supporting layer 20 may also serve to ensure that the pod 1 is not displaced from the socket opening 102 or disintegrates. The supporting layer 20 may comprise a biodegradable material.

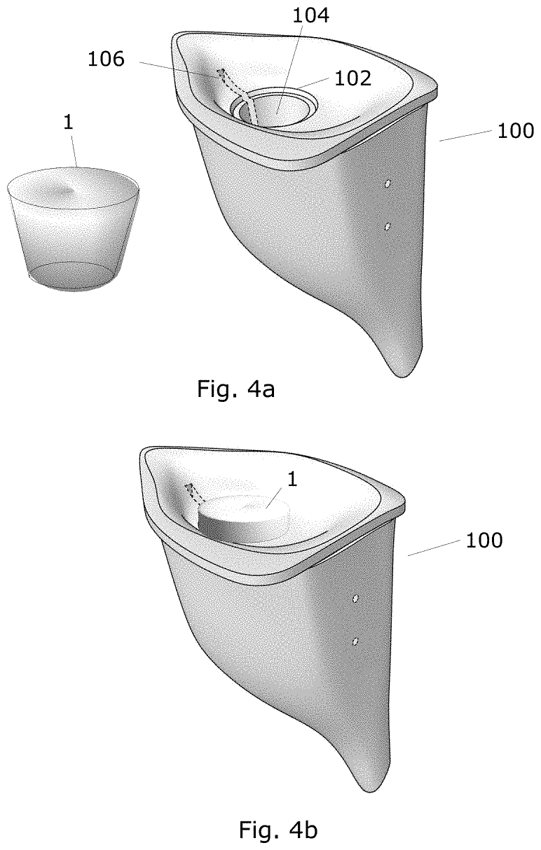

FIGS. 4a and 4b show embodiments of the pod 1 and the socket 100. In FIG. 4a, the pod 1 and the socket 100 are shown side by side. FIG. 4b shows the pod 1 placed into the socket 100.

The socket 100 may correspond to a cup for growing plants, described for example in the applicant's patent application EP 3 251 499 A1. A plurality of such cups may be placed inside a plant growth cabinet, where plants may be grown in them. A pod 1 can be placed into each of the cups 100, and multiple different plants can be grown simultaneously in a plant growth cabinet.

The socket 100 comprises a socket opening 102. Inside the socket opening 102 is a socket cavity 104. When the pod 1 is fitted to the socket 100, most of it may be contained within the cavity 104. The depth of the cavity 104 is preferably larger than the height of the portion of the pod 1 fitting within the cavity 104. This is to allow roots of seedlings and later plants to remain suspended within the cavity 104.

The pod 1 preferably snugly fits within the socket opening 102. In this way, light reaching the socket cavity can be severely limited, and the roots of plants growing from the pod 1 protected from it. This is shown in FIG. 4b, with the socket opening 102 fully covered by the pod 1 once it is inserted into the cavity 104.

The socket 100 further comprises a socket channel 106. The socket channel 106 may allow liquid (preferably water with nutrients) to reach the inside of opening 102 (so the cavity 104) when the pod 1 is fitted to the socket 100. In this way, water and nutrients may still reach the roots of the plants growing from the pod 1.

### LIST OF REFERENCE NUMERALS

1—pod

2—body

4—top surface

6—bottom surface

8—side surface

10—pod indentation

12—protective layer

14—enclosed space of the protective layer

16—seed

20—supporting layer

22—supporting layer aperture

100—socket

102—socket opening

104—socket cavity

106—socket channel

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be the preferred order, but it may not be mandatory to carry out the steps in the recited order. That is, unless otherwise specified or unless clear to the skilled person, the order in which steps are recited may not be mandatory. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1. A pod for hydroponically growing plants, the pod comprising
a body comprising a top surface, a bottom surface and at least one side surface, said side surface connecting the top surface and the bottom surface;
wherein the body comprises an indentation; and
wherein a contour of the top surface of the body is larger than a contour of the bottom surface of the body.

2. The pod according to claim 1, wherein the side surface substantially corresponds to a surface of revolution created by rotating a line segment about the axis connecting a center of the contour of the top surface and a center of the contour of the bottom surface, and wherein the angle between a line comprising the line segment and said axis comprises 5 to 45 degrees.

3. The pod according to claim 1, wherein the ratio of the contour of the top surface to the contour of the bottom surface comprises between 1.5 and 2.

4. The pod according to claim 1, further comprising a protective layer forming a barrier between at least a part of the indentation in the body and surrounding medium.

5. The pod according to claim 4, wherein the protective layer is soluble in water.

6. The pod according to claim 4, wherein the protective layer has a surface area substantially corresponding to a truncated spherocylinder.

7. The pod according to claim 4, wherein the protective layer comprises an enclosed space.

8. The pod according to claim 7, wherein the enclosed space comprises at least one atmospheric parameter independent of protective layer surroundings' atmospheric parameters.

9. The pod according to claim 7, wherein the protective layer is configured to fix seeds within the enclosed space.

10. The pod according to claim 9, wherein the protective layer is fitted to the body of the pod configured to withstand a separating force of at least 0.1 N.

11. The pod according to claim 1, further comprising a supporting layer adjacent to the top surface.

12. A system for growing plants, the system comprising
a pod comprising a body comprising a top surface, a bottom surface and at least one side surface, said side surface connecting the top surface and the bottom surface; and
a socket comprising an opening configured to receive the pod;
wherein a contour of the bottom surface is smaller than a contour of the socket opening; and
wherein a contour of the top surface is larger than a contour of the socket opening.

13. The system according to claim 12, further comprising a protective layer configured to be fitted to an indentation of the pod body.

14. The system according to claim 12, wherein the protective layer comprises a capsule configured to encapsulate seeds.

15. The system according to claim 12, further comprising a supporting layer configured to maintain pod integrity.

16. The system according to claim 15, wherein the supporting layer is configured to be simultaneously adjacent to the pod and the socket.

17. The system according to claim 12, configured to be used with a hydroponic plant growth cabinet.

18. The pod according to claim 5, wherein the protective layer has a surface area substantially corresponding to a truncated spherocylinder.

19. The system according to claim 13, wherein the protective layer comprises a capsule configured to encapsulate seeds.
